(19) United States
(12) Patent Application Publication
(10) Pub. No.: US 2021/0239338 A1
(43) Pub. Date: Aug. 5, 2021

(54) ARTIFICIAL INTELLIGENCE DEVICE FOR FREEZING PRODUCT AND METHOD THEREFOR

(71) Applicant: LG ELECTRONICS INC., Seoul (KR)

(72) Inventor: Hyunseung SHIM, Seoul (KR)

(73) Assignee: LG ELECTRONICS INC., Seoul (KR)

(21) Appl. No.: 17/037,504

(22) Filed: Sep. 29, 2020

(30) Foreign Application Priority Data
Jan. 30, 2020 (KR) 10-2020-0010897

(51) Int. Cl. F24F 11/30; F25D 29/00; G08B 21/18

(52) U.S. Cl. CPC F24F 11/30; F25D 29/005; F25D 29/008; F25D 2600/06; F25D 2700/123; F25D 2600/02; G08B 21/182

(57) ABSTRACT

An artificial intelligence device includes a temperature sensor configured to measure a temperature of a product to be frozen, and a processor configured to acquire, via the temperature sensor, temperature distribution information about at least a part of the product, acquire frozen state information including at least one of freezing progress information, surface temperature information, or ambient temperature information about the product, based on the temperature distribution information about the product, and acquire a remaining freezing time until the product is frozen to a target frozen state, based on the frozen state information about the product.

### CROSS-REFERENCE TO RELATED APPLICATIONS

Pursuant to 35 U.S.C. § 119(a), this application claims the benefit of earlier filing date and right of priority to Korean Patent Application No. 10-2020-0010897, filed on Jan. 30, 2020, the contents of which are hereby incorporated by reference herein in its entirety.

### BACKGROUND

The present disclosure relates to an artificial intelligence (AI) device for managing freezing of products and a method therefor.

Artificial intelligence is a field of computer engineering and information technology for researching a method of enabling a computer to do thinking, learning and self-development that can be done by human intelligence, and means that a computer can imitate a human intelligent action.

In addition, artificial intelligence does not exist in itself but has many direct and indirect associations with the other fields of computer science. In particular, today, attempts to introduce artificial intelligent elements to various fields of information technology to deal with issues of the fields have been actively made.

Meanwhile, technology for recognizing and learning a surrounding situation using artificial intelligence and providing information desired by a user in a desired form or performing a function or operation desired by the user is actively being studied.

An electronic device for providing such operations and functions may be referred to as an AI device.

Meanwhile, freezing apparatuses such as conventional refrigerators freeze products by maintaining a constant temperature.

However, when the product is frozen by continuously maintaining a constant temperature, there is a problem that the product is excessively frozen.

For example, there is a risk of breaking a bottle if a beverage in a glass bottle is excessively frozen. In addition, since the product is frozen at a constant temperature regardless of the freezing progress state of the product, there is a problem that it is difficult for a user to freeze the product as much as a desired frozen state. In addition, in order to check the frozen state of the product, there is a problem that the user must directly check the frozen state of the product.

Therefore, there is an increasing need for an AI device capable of setting a freezing plan of a product received in a freezing apparatus, such as a refrigerator, and estimating a frozen state of a product.

### SUMMARY

The present disclosure aims to solve the above and other problems.

The present disclosure provides an artificial intelligence device for managing freezing of a product and a method therefor.

The present disclosure provides an artificial intelligence device capable of estimating a frozen state of a product and a method therefor.

The present disclosure provides an artificial intelligence device for allowing freezing of a product to progress as desired by a user and a method therefor.

The present disclosure provides an artificial intelligence device allowing a user to know a frozen state of a product and a method therefor.

According to an embodiment of the present disclosure, an artificial intelligence device includes a temperature sensor configured to measure a temperature of a product to be frozen, and a processor configured to acquire, via the temperature sensor, temperature distribution information about at least a part of the product, acquire frozen state information including at least one of freezing progress information, surface temperature information, or ambient temperature information about the product, based on the temperature distribution information about the product, and acquire a remaining freezing time until the product is frozen to a target frozen state, based on the frozen state information about the product.

According to an embodiment of the present disclosure, a product freezing method includes measuring a temperature of a product to be frozen, acquiring temperature distribution information about at least a part of the product, acquiring frozen state information including at least one of freezing progress information, surface temperature information, or ambient temperature information about the product, based on the temperature distribution information about the product, and acquiring a remaining freezing time until the product is frozen to a target frozen state, based on the frozen state information about the product.

The details of one or more embodiments are set forth in the accompanying drawings and the description below. Other features will be apparent from the description and drawings, and from the claims.

### BRIEF DESCRIPTION OF THE DRAWINGS

FIG. 1 illustrates an AI device according to an embodiment of the present disclosure.

FIG. 2 illustrates an AI server according to an embodiment of the present disclosure.

FIG. 3 illustrates an AI system according to an embodiment of the present disclosure.

FIG. 4 is a block diagram illustrating an artificial intelligence apparatus according to the present disclosure.

FIG. 5 is a flowchart illustrating a method for managing freezing of a product according to an embodiment of the present disclosure.

FIG. 6 is a diagram for describing a position of a temperature sensor according to an embodiment of the present disclosure.

FIG. 7 is a diagram for describing a position of a temperature sensor according to an embodiment of the present disclosure.

FIG. 8 is a diagram for describing a frozen state recognition model according to an embodiment of the present disclosure.

FIG. 9 is a flowchart illustrating a method for managing freezing of a product according to an embodiment of the present disclosure.

FIG. 10 is a diagram for describing a freezing completion time prediction model according to an embodiment of the present disclosure.

### DETAILED DESCRIPTION OF THE EMBODIMENTS

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the invention in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

<Artificial Intelligence (AI)>

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driver including an actuator or a motor and may perform various physical operations such as moving a robot joint. In addition, a movable robot may include a wheel, a brake, a propeller, and the like in a driver, and may travel on the ground through the driver or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

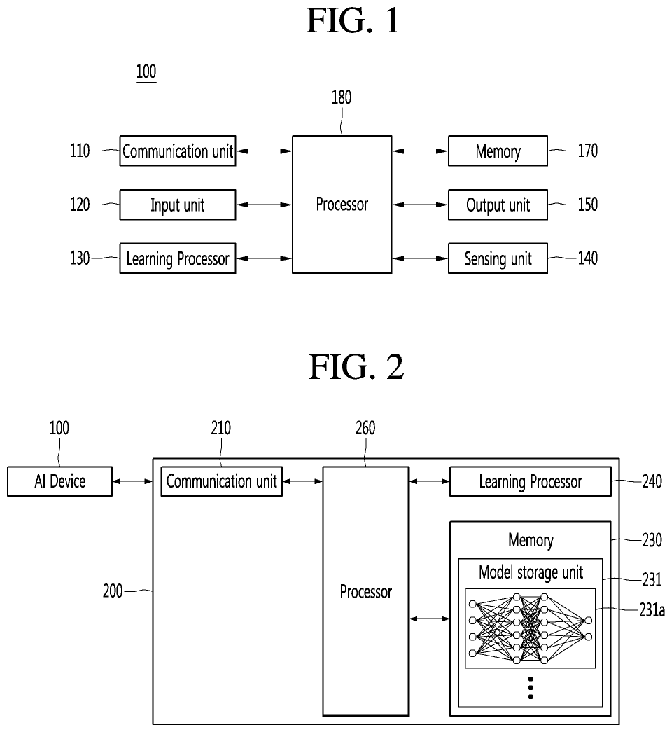

FIG. 1 illustrates an AI device 100 according to an embodiment of the present invention.

The AI device (or an AI apparatus) 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication interface 110, an input interface 120, a learning processor 130, a sensor 140, an output interface 150, a memory 170, and a processor 180.

The communication interface 110 may transmit and receive data to and from external devices such as other AI devices 100a to 100e and the AI server 200 by using wire/wireless communication technology. For example, the communication interface 110 may transmit and receive sensor information, a user input, a learning model, and a control signal to and from external devices.

The communication technology used by the communication interface 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input interface 120 may acquire various kinds of data.

At this time, the input interface 120 may include a camera for inputting a video signal, a microphone for receiving an audio signal, and a user input interface for receiving information from a user. The camera or the microphone may be treated as a sensor, and the signal acquired from the camera or the microphone may be referred to as sensing data or sensor information.

The input interface 120 may acquire a learning data for model learning and an input data to be used when an output is acquired by using learning model. The input interface 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensor 140 may acquire at least one of internal information about the AI device 100, ambient environment information about the AI device 100, and user information by using various sensors.

Examples of the sensors included in the sensor 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output interface 150 may generate an output related to a visual sense, an auditory sense, or a haptic sense.

At this time, the output interface 150 may include a display for outputting time information, a speaker for outputting auditory information, and a haptic module for outputting haptic information.

The memory 170 may store data that supports various functions of the AI device 100. For example, the memory 170 may store input data acquired by the input interface 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI device 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present invention.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication interface 210, a memory 230, a learning processor 240, a processor 260, and the like.

The communication interface 210 can transmit and receive data to and from an external device such as the AI device 100.

The memory 230 may include a model storage 231. The model storage 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

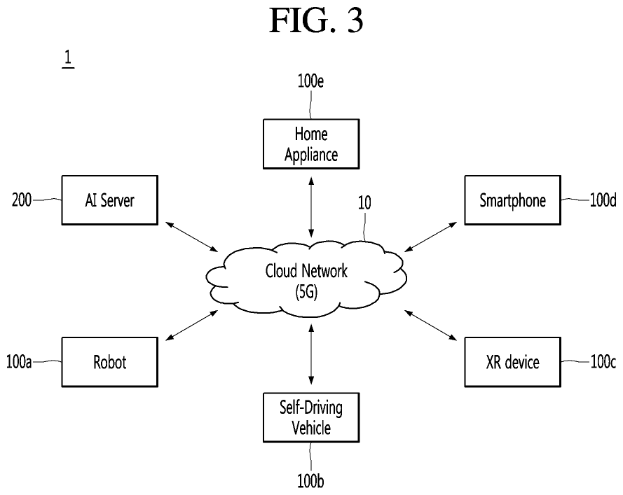

FIG. 3 illustrates an AI system 1 according to an embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driver such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driver based on the control/interaction of the user. At this time, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driver such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driver based on the control/interaction of the user. At this time, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driver of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

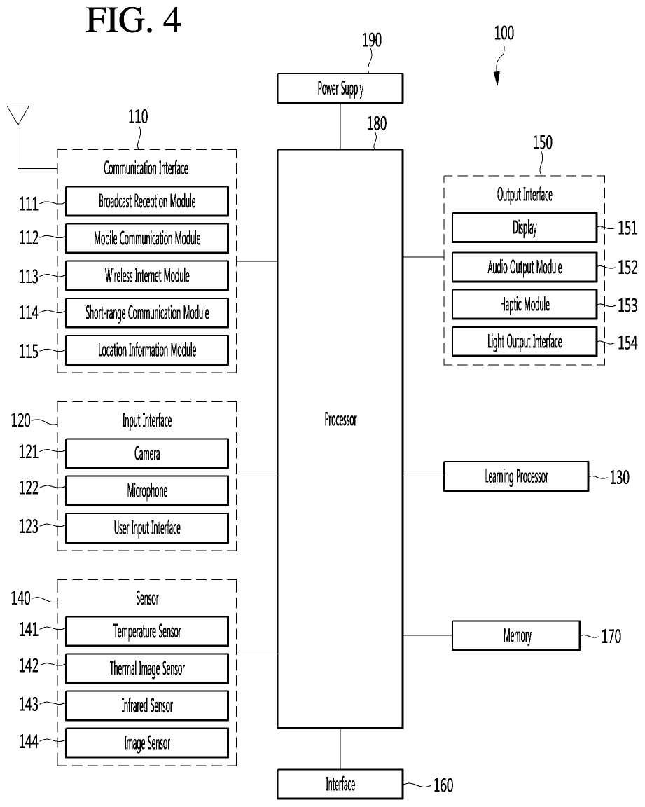

FIG. 4 is a block diagram illustrating an AI device according to the present disclosure.

A description overlapping FIG. 1 will be omitted.

The communication interface 110 may include at least one of a broadcast reception module 111, a mobile communication module 112, a wireless Internet module 113, a short-range communication module 114 and a location information module 115.

The broadcast reception module 111 receives broadcast signals and/or broadcast associated information from an external broadcast management server through a broadcast channel.

The mobile communication module 112 may transmit and/or receive wireless signals to and from at least one of a base station, an external terminal, a server, and the like over a mobile communication network established according to technical standards or communication methods for mobile communication (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

The wireless Internet module 113 is configured to facilitate wireless Internet access. This module may be installed inside or outside the AI device 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like.

The short-range communication module 114 is configured to facilitate short-range communication and to support short-range communication using at least one of Bluetooth™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The location information module 115 is generally configured to acquire the position (or the current position) of the mobile AI device. Representative examples thereof include a Global Position System (GPS) module or a Wi-Fi module. As one example, when the AI device uses a GPS module, the position of the mobile AI device may be acquired using a signal sent from a GPS satellite.

The input interface 120 may include a camera 121 for receiving a video signal, a microphone 122 for receiving an audio signal, and a user input interface 123 for receiving information from a user.

The camera 121 may process image frames of still images or moving images obtained by image sensors in a video call more or an image capture mode. The processed image frames can be displayed on the display 151 or stored in memory 170.

The microphone 122 processes an external acoustic signal into electrical audio data. The processed audio data may be variously used according to function (application program) executed in the AI device 100. Meanwhile, the microphone 122 may include various noise removal algorithms to remove noise generated in the process of receiving the external acoustic signal.

The user input interface 123 receives information from a user. When information is received through the user input interface 123, the processor 180 may control operation of the AI device 100 in correspondence with the input information.

The user input interface 123 may include one or more of a mechanical input element (for example, a mechanical key, a button located on a front and/or rear surface or a side surface of the AI device 100, a dome switch, a jog wheel, a jog switch, and the like) or a touch input element. As one example, the touch input element may be a virtual key, a soft key or a visual key, which is displayed on a touchscreen through software processing, or a touch key located at a location other than the touchscreen.

The sensor 140 may include a temperature sensor 141, a thermal image sensor 142, and an infrared sensor 143.

The temperature sensor 141 may measure a temperature of a temperature measurement object. The temperature sensor 141 may include a contact temperature sensor that contacts a measurement object and measures temperature in response to a change in temperature thereof, or a non-contact temperature sensor that senses energy emitted by the measurement object.

The temperature sensor 141 may include the thermal image sensor 142 that acquires a thermal image of the measurement object. The thermal image sensor 142 may be included in a thermal imaging camera.

In addition, the temperature sensor 141 may include the infrared sensor 143 that measures a temperature of at least a part of the measurement object. The infrared sensor 143 may sense the temperature of the measurement object by measuring the amount of infrared energy emitted from the surface of the measurement object. The infrared sensor 143 may be referred to as an infrared laser thermometer.

Meanwhile, the sensor 140 may include an image sensor 144. The image sensor 140 may acquire an image by photographing an object.

The output interface 150 is typically configured to output various types of information, such as audio, video, tactile output, and the like. The output interface 150 may include a display 151, an audio output module 152, a haptic module 153, and a light output interface 154.

The display 151 is generally configured to display (output) information processed in the AI device 100. For example, the display 151 may display execution screen information of an application program executed by the AI device 100 or user interface (UI) and graphical user interface (GUI) information according to the executed screen information.

The display 151 may have an inter-layered structure or an integrated structure with a touch sensor in order to realize a touchscreen. The touchscreen may provide an output interface between the AI device 100 and a user, as well as function as the user input interface 123 which provides an input interface between the AI device 100 and the user.

The audio output module 152 is generally configured to output audio data received from the wireless communication interface 110 or stored in the memory 170 in a call signal reception mode, a call mode, a record mode, a speech recognition mode, a broadcast reception mode, and the like.

The audio output module 152 may also include a receiver, a speaker, a buzzer, or the like.

A haptic module 153 can be configured to generate various tactile effects that a user feels. A typical example of a tactile effect generated by the haptic module 153 is vibration.

A light output interface 154 may output a signal for indicating event generation using light of a light source of the AI device 100. Examples of events generated in the AI device 100 may include message reception, call signal reception, a missed call, an alarm, a schedule notice, email reception, information reception through an application, and the like.

An interface 160 serves as an interface with external devices to be connected with the AI device 100. The interface 160 may include wired or wireless headset ports, external power supply ports, wired or wireless data ports, memory card ports, ports for connecting a device having an identification module, audio input/output (I/O) ports, video I/O ports, earphone ports, or the like. The AI device 100 may perform appropriate control related to the connected external device in correspondence with connection of the external device to the interface 160.

The identification module may be a chip that stores a variety of information for granting use authority of the AI device 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the AI device 100 via the interface 160.

The power supply 190 receives external power or internal power and supplies the appropriate power required to operate respective components included in the AI device 100, under control of the processor 180. The power supply 190 may include a battery, and the battery may be a built-in or rechargeable battery.

Meanwhile, as described above, the processor 180 controls operation related to the application program and overall operation of the AI device 100. For example, the processor 180 may execute or release a lock function for limiting input of a control command of the user to applications when the state of the mobile AI device satisfies a set condition.

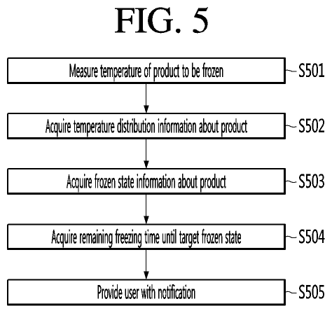

FIG. 5 is a flowchart illustrating a method for managing freezing of a product according to an embodiment of the present disclosure.

The temperature sensor 141 may measure a temperature of a product to be frozen (S501).

The product to be frozen may be a product in which a liquid beverage is contained in a PET bottle, a glass bottle, or a plastic bottle, but is not limited thereto.

The temperature sensor 141 may measure the temperature of the product when the freezing is started. For example, the temperature sensor 141 may measure the temperature of the product when the product is input to the freezing apparatus and the freezing is started.

The temperature sensor 141 may be provided in a space where the product is frozen.

For example, the temperature sensor 141 may be provided in a freezing compartment of a refrigerator.

In addition, the temperature sensor 141 may be provided in a quick freezing compartment in which a quick freezing function is performed in the refrigerator.

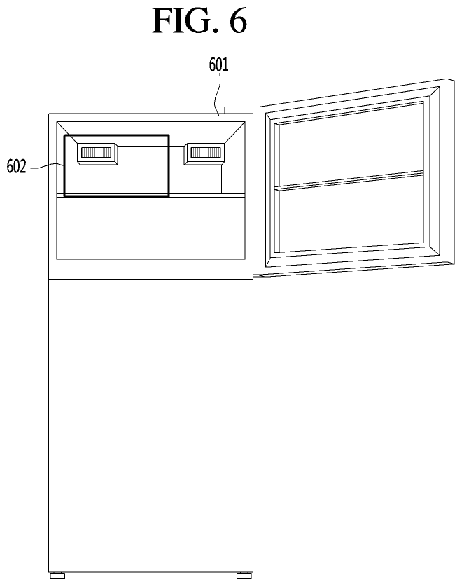

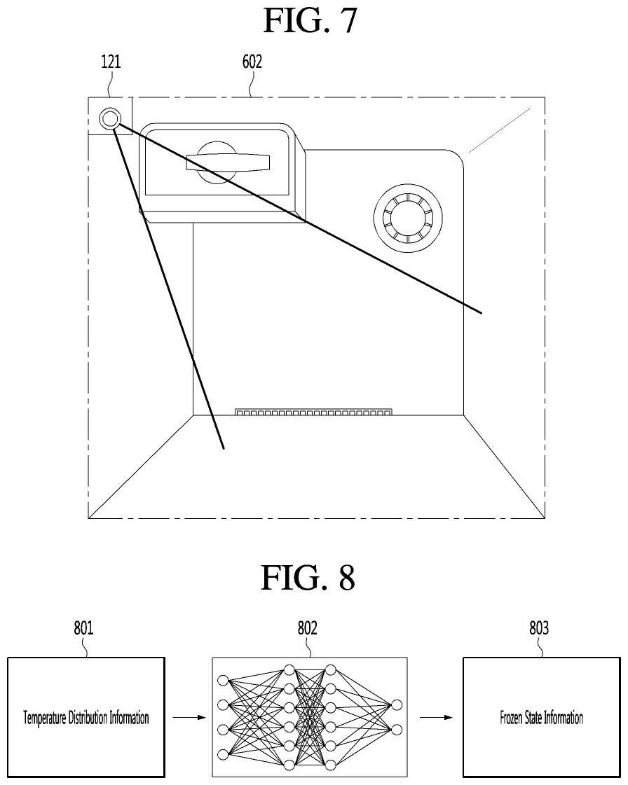

Referring to FIGS. 6 and 7, the temperature sensor 141 may be provided inside a quick freezing compartment 602 of a refrigerator 601.

One or more temperature sensors 141 may be provided at the upper left or upper right of the quick freezing compartment 602 so as to measure the temperature of at least a part of the product to be frozen.

In this case, the one or more temperature sensors 141 may each include at least one of a thermal image sensor 142 or an infrared sensor 143.

Meanwhile, the temperature sensor 141 is not necessarily limited to be provided inside the refrigerator 601, and the temperature sensor 141 may also be provided outside the refrigerator 601.

Meanwhile, the temperature sensor 141 may include the thermal image sensor 142 that acquires a thermal image of the product to be frozen.

Meanwhile, the temperature sensor 141 may include an infrared sensor that measures the temperature of at least a part of the product to be frozen.

The processor 180 may acquire, via the temperature sensor 141, temperature distribution information about at least a part of the product (S502).

The temperature distribution information may include information about the surface temperature of each part of the product. In addition, the temperature distribution information may include information about the temperature around the product.

In addition, the processor 180 may acquire, via the temperature sensor 141, the temperature distribution information about the product at a predetermined period. For example, when the temperature sensor 141 is provided in a space where the product is frozen, the temperature distribution information about the product may be acquired at a predetermined period while the product is frozen. Therefore, the processor 180 may monitor the temperature of the product in real time.

In addition, the processor 180 may acquire, via the thermal image sensor 142, a thermal image including the temperature distribution information about at least a part of the product.

The processor 180 may acquire frozen state information including at least one of freezing progress information, surface temperature information, or ambient temperature information about the product, based on the temperature distribution information about the product (S503).

The freezing progress information may include information about a degree to which a liquid contained in the product is frozen into a solid. The freezing progress information may be expressed in percent (%). For example, if the liquid contained in the product is all frozen into a solid, the freezing progress information can be 100%, and if half of the liquid contained in the product is frozen into a solid, the freezing progress information can be 50%.

In addition, the surface temperature information about the product may include information about the surface temperature of the product that may be changed as the freezing is progressed. In addition, the surface temperature information about the product may include surface temperature information about a region that the temperature sensor 141 has not measured. For example, the surface temperature information about the product may include information about the surface temperature of the product that is outside the measurement range of the temperature sensor.

In addition, the ambient temperature information about the product may include information about the ambient temperature of the product to be frozen. In addition, the ambient temperature information about the product may include the ambient temperature information about the product that the temperature sensor 141 has not measured.

Meanwhile, the processor 180 may input the temperature distribution information about the product to a frozen state recognition model and acquire frozen state information about the product output by the frozen state recognition model.

In addition, the processor 180 may input the thermal image of the product to the frozen state recognition model and acquire frozen state information about the product output by the frozen state recognition model.

Referring to FIG. 8, the processor 180 may input temperature distribution information 801 about the product to the frozen state recognition model 802 and acquire frozen state information 803 about the product output from the frozen state recognition model 802.

The frozen state recognition model may be an artificial neural network model trained to output predetermined frozen state information about a product from predetermined temperature distribution information.

The frozen state recognition model may also be an artificial neural network model trained to output predetermined frozen state information about a product from a predetermined thermal image.

The frozen state recognition model may be an artificial neural network (ANN) model used in machine learning. The frozen state recognition model may include artificial neurons (nodes) that form a network by connection of synapses. The frozen state recognition model may be defined by a connection pattern between neurons of other layers, a learning process of updating model parameters, and an activation function of generating an output value.

The frozen state recognition model may include an input layer, an output layer, and optionally one or more hidden layers. Each layer may include one or more neurons, and the artificial neural network may include synapses that connect neurons to neurons. In the artificial neural network, each neuron may output a function value of an active function for input signals, weights, and deflections, which are input through the synapse.

The frozen state recognition model may be generated through supervised learning, unsupervised learning, or reinforcement learning according to a learning method.

For example, when the frozen state recognition model is generated through supervised learning, the frozen state recognition model may be trained in a state in which a label for training data is given. The label may mean a correct answer (or a result value) that the artificial neural network has to infer when the training data is input to the artificial neural network.

The learning processor 130 may designate a label specifying the frozen state information about the product with respect to the temperature distribution information about at least a part of the predetermined product. For example, each of a plurality of temperature distribution information may be designated by labeling frozen state information including at least one of freezing progress information, surface temperature information, or ambient temperature information. Therefore, the learning processor 130 may label the frozen state information corresponding to the temperature distribution information received when the temperature distribution information is input, and may train the frozen state recognition model to output the frozen state of the product as the temperature distribution information about the product.

In addition, temperature distribution information about at least a part of a certain product may include a thermal image of the product. Therefore, the learning processor 130 may train the frozen state recognition model by labeling the frozen state information corresponding to each of a plurality of thermal images. Therefore, when a new thermal image is input, the frozen state information about the product may be output to determine the freezing progress degree of the product.

Meanwhile, the processor 180 may acquire the remaining freezing time until the product is frozen to a target frozen state, based on the frozen state information about the product (S504).

The target frozen state may include at least one of the freezing progress degree of the product desired by the user, the surface temperature information, or the ambient temperature information when the product is frozen. For example, the target frozen state may be set to a freezing progress degree of 50% and a surface temperature −5° C.

The input interface 120 may receive the target frozen state from the user. The processor 180 may set the target frozen state based on the target frozen state input by the user.

Meanwhile, the memory 170 may include a product database that stores a target frozen state value according to a product type and a product capacity. Therefore, the processor 180 may set the target frozen state based on the product type and the product capacity.

The processor 180 may input the frozen state information and the target frozen state to the freezing completion time prediction model and acquire the remaining freezing time output by the freezing completion time prediction model.

The freezing completion time prediction model may be an artificial neural network model trained to output the remaining freezing time of the product until the target frozen state from the predetermined frozen state information and the predetermined target frozen state.

When the frozen state recognition model is generated through supervised learning, the frozen state recognition model may be trained in a state in which a label for training data is given.

The learning processor 130 may designate a label that specifies the remaining freezing time with respect to the predetermined frozen state information and the predetermined target frozen state information. For example, when the freezing progress degree is 10% and the freezing progress degree of the target frozen state is 50%, it may be labeled to specify that the remaining freezing time is 30 minutes. Therefore, the learning processor 130 may train the freezing completion time prediction model by using the training data that labels the remaining freezing time corresponding to the predetermined frozen state information and the predetermined target frozen state information.

The processor 180 may provide a user with a notification including information about the freezing of the product (S505).

The communication interface 110 may transmit information about the remaining freezing time to an external device.

The processor 180 may transmit the remaining freezing time information to the external device (not shown) through the communication interface 110. The external device may include a user's smartphone or the like.

In addition, the processor 180 may transmit the frozen state information to the external device through the communication interface 110. Therefore, the user can check the remaining time until the product is frozen and can check the frozen state of the product without checking the product directly.

In addition, the processor 180 may output the remaining freezing time or the frozen state information through the display 151. In addition, the processor 180 may provide a voice notification regarding the remaining freezing time or the frozen state information through the audio output module 152.

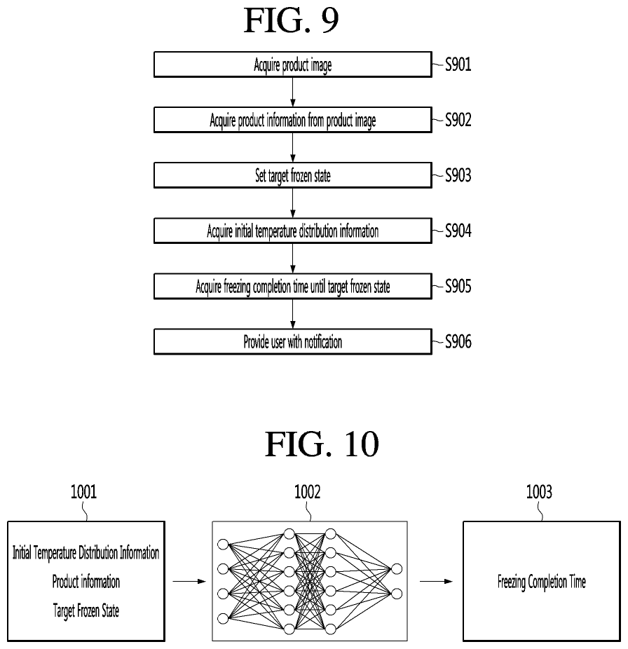

FIG. 9 is a flowchart illustrating a method for managing freezing of a product according to an embodiment of the present disclosure.

The image sensor 144 may acquire a product image of a product to be frozen (S901).

The image sensor 144 may include an RGB image sensor as a sensor capable of acquiring the image of the product. The image sensor 144 may be included in a camera, and the camera may process a frame of an image acquired by the image sensor.

The processor 180 may acquire product information including at least one of a product type or product capacity information about the product based on the product image (S902).

The product type may be classified based on the type of beverage contained in the product, the material of the bottle containing the product, and the like. In addition, the product capacity information may be information about the product capacity expressed in liters.

The memory 170 may store a product database that stores the product type and product capacity information for each of various product images.

The processor 180 may search the product database for a product image matching the acquired product image and may acquire the product type and product capacity information about the product image.

In addition, the processor 180 may input the product image to the product recognition model and acquire product information output by the product recognition model.

The product recognition model may be an artificial neural network model trained to output product type and product capacity information from a predetermined product image.

When the product recognition model is generated through supervised learning, the product recognition model may be trained in a state in which a label for training data is given.

The learning processor 130 may designate a label that specifies a product type and a product capacity for a predetermined product image. For example, for an image of a glass bottle containing 500-ml cola, a label that specifies that a product type is cola and a product volume is 500 ml may be possible. Therefore, the learning processor 130 may train the product recognition model using training data that labels the product type and the product capacity corresponding to the predetermined product image.

The processor 180 may set the target frozen state based on the product type and the product capacity included in the product information (S904).

The memory 170 may include the product database that stores the target frozen state value according to the product type and the product capacity.

Based on the product database, the processor 180 may set the target frozen state based on the product type and the product capacity.

The processor 180 may acquire, via the temperature sensor 141, initial temperature distribution information about the product when the freezing of the product is started (S905).

The temperature sensor 141 may measure the temperature of at least a part of the product when the product is input to the freezing apparatus and the freezing is started.

For example, the thermal image sensor 142 may acquire a thermal image of at least a part of the product when the product is input to the freezing apparatus and the freezing is started.

The processor 180 may acquire a freezing completion time until the product is frozen to a target frozen state, based on the initial temperature distribution information and the product information (S906).

The processor 180 may input the initial temperature distribution information, the product information, and the target frozen state to the freezing completion time prediction model and acquire the freezing completion time of the product output by the freezing completion time prediction model.

The freezing completion time prediction model may be an artificial neural network model trained to output a predetermined freezing completion time from predetermined temperature distribution information, predetermined product information, and a predetermined target frozen state.

Referring to FIG. 10, the processor 180 may input, to the freezing completion time prediction model 1002, input data 1001 including the initial temperature distribution information, the product information, and the target frozen state and acquire a freezing completion time 1003 of the product output by the freezing completion time prediction model 1002.

When the freezing completion time prediction model is generated through supervised learning, the freezing completion time prediction model may be trained in a state in which a label for training data is given.

The learning processor 130 may designate a label specifying the freezing completion time that can be frozen to the target frozen state with respect to the predetermined temperature distribution information, the product information, and the target frozen state. For example, a label specifying that a freeze complete time is 15 minutes is possible with respect to a thermal image including the initial temperature distribution information, the product type of “cola”, the product volume of “500 ml”, the target freezing progress degree of “10%” and the target surface temperature of −5° C. Therefore, the learning processor 130 may train the product recognition model by using the predetermined temperature distribution information, the product information, and the training data that labels the freezing completion time corresponding to the target frozen state.

Therefore, the processor 180 may acquire an accurate freezing completion time until freezing is completed at the initial temperature of the product according to the product type and the product capacity.

The processor 180 may provide the user with a notification regarding the freezing completion time (S907).

The processor 180 may transmit the notification regarding the freezing completion time to the external device through the communication interface 110. In this case, the external device may be a smartphone or the like used by the user. Therefore, when the user freezes the product, the user can check the freezing completion time until the product is frozen at the optimal temperature.

According to an embodiment of the present disclosure, it is possible to know the frozen state of the product being frozen in real time.

In addition, according to various embodiments of the present disclosure, it is possible to prevent excessive freezing that may occur when the product is frozen.

In addition, according to various embodiments of the present disclosure, the user can freeze the product as desired, thereby improving the satisfaction of the freezing function.

Furthermore, according to various embodiments of the present disclosure, even if the product is not directly checked, the time taken for the product to be frozen at an optimal temperature can be confirmed.

The present disclosure may be embodied as computer-readable codes on a program-recorded medium. The computer-readable recording medium may be any recording medium that can store data which can be thereafter read by a computer system. Examples of the computer-readable medium may include a hard disk drive (HDD), a solid state disk (SSD), a silicon disk drive (SDD), a ROM, a RAM, a CD-ROM, a magnetic tape, a floppy disk, and an optical data storage device. The computer may also include the processor 180 of the artificial intelligence apparatus.

What is claimed is:

1. An artificial intelligence device comprising:
a temperature sensor configured to measure a temperature of a product; and
a processor configured to:
determine, via the temperature sensor, temperature distribution information corresponding to at least a part of the product, wherein the temperature distribution information includes at least a surface temperature of each part of the product or information about an environmental temperature around the product;
determine frozen state information based on the determined temperature distribution information, wherein the frozen state information includes at least one of freezing progress information, surface temperature information, or ambient temperature information associated with the product; and
determine a remaining freezing time based on the determined frozen state information, wherein the remaining freezing time corresponds to a time remaining until the product is frozen to a target frozen state.

2. The artificial intelligence device of claim 1, wherein the frozen state information is determined by inputting the determined temperature distribution information to a frozen state recognition model, and wherein the frozen state recognition model is a neural network model trained to output predetermined frozen state information about a particular product from predetermined temperature distribution information.

3. The artificial intelligence device of claim 1, further comprising a thermal image sensor configured to capture a thermal image of the product, and wherein the processor is further configured to capture, via the thermal image sensor, a thermal image including the temperature distribution information corresponding to the at least a part of the product.

4. The artificial intelligence device of claim 3, wherein the frozen state information is determined by inputting the captured thermal image to a frozen state recognition model, and wherein the frozen state recognition model is a neural network model trained to output predetermined frozen state information about a particular product from a predetermined thermal image.

5. The artificial intelligence device of claim 1, wherein the temperature sensor corresponds to an infrared sensor.

6. The artificial intelligence device of claim 1, wherein the remaining freezing time is determined by inputting the determined frozen state information and the target frozen state to a freezing completion time prediction model, and wherein the freezing completion time prediction model is a neural network model trained to output a particular remaining freezing time of a particular product, wherein the particular remaining freezing time corresponds to a time remaining until the product reaches a the target frozen state from a predetermined frozen state information and a predetermined target frozen state.

7. The artificial intelligence device of claim 1, further comprising a communication interface configured to transmit information about the determined remaining freezing time to an external device.

8. The artificial intelligence device of claim 1, further comprising an image sensor configured to capture a product image associated with the product,
wherein the processor is further configured to:
determine product information based on the captured product image, wherein the product information includes at least one of a product type or a product volume capacity information about the product;
determine, via the temperature sensor, initial temperature distribution information about the product based on when freezing of the product begins; and
determine a freezing completion time based on the determined initial temperature distribution information and the determined product information, wherein the freezing completion time corresponds to a time remaining until the product is frozen to the target frozen state.

9. The artificial intelligence device of claim 8, wherein the processor is further configured to set the target frozen state based on the determined product type or the determined product volume capacity.

10. The artificial intelligence device of claim 8, wherein the remaining freezing time is determined based on inputting the determined initial temperature distribution information, the determined product information, and the target frozen state to a freezing completion time prediction model, and wherein the freezing completion time prediction model is an neural network model trained to output a predetermined freezing completion time from predetermined temperature distribution information, predetermined product information, and a predetermined target frozen state.

11. The artificial intelligence device of claim 1, wherein the temperature sensor is located in a space where the product is frozen.

12. A method comprising:
measuring a temperature of a product;
determining temperature distribution information corresponding to at least a part of the product, wherein the temperature distribution information includes at least a surface temperature of each part of the product or information about an environmental temperature around the product;
determining frozen state information based on the determined temperature distribution information, wherein the frozen state information includes at least one of freezing progress information, surface temperature information, or ambient temperature information about the product; and
determining a remaining freezing time based on the determined frozen state information, wherein the remaining freezing time corresponds to a time remaining until the product is frozen to a target frozen state.

13. The method according of claim 12, wherein the frozen state information is determined by inputting the determined temperature distribution information to a frozen state recognition model, and wherein the frozen state recognition model is a neural network model trained to output predetermined frozen state information about a particular product from predetermined temperature distribution information.

14. The method of claim 12, wherein determining the temperature distribution information comprises capturing a thermal image including the temperature distribution information corresponding to the least a part of the product.

15. The method of claim 14, wherein the frozen state information is determined by inputting the captured thermal image to a frozen state recognition model, wherein the frozen state recognition model is a neural network model trained to output predetermined frozen state information about a particular product from a predetermined thermal image.

16. The method of claim 12, wherein the remaining freezing time is determined by inputting the determined frozen state information and the target frozen state to a freezing completion time prediction model; and wherein the freezing completion time prediction model is a neural network model trained to output a particular remaining freezing time of a particular product, wherein the particular remaining freezing time corresponds to a time remaining until the product reaches the target frozen state from a predetermined frozen state information and a predetermined target frozen state.

17. The method of claim 12, further comprising transmitting information about the remaining freezing time to an external device.

18. The method of claim 12, further comprising:
capturing a product image associated with the product;
determining product information based on the captured product image, wherein the product information includes at least a product type or a product volume capacity information about the product;
determining initial temperature distribution information about the product based on when the freezing of the product begins; and
determining a freezing completion time based on the determined initial temperature distribution information and the determined product information, wherein the freezing completion time corresponds to a time remaining until the product is frozen to the target frozen state.

19. The method of claim 18, further comprising setting the target frozen state based on the determined product type or the determined product volume capacity.

20. The method of claim 18, wherein the remaining freezing time is determined by inputting the determined initial temperature distribution information, the determined product information, and the target frozen state to a freezing completion time prediction model, and wherein the freezing completion time prediction model is a neural network model trained to output a predetermined freezing completion time from predetermined temperature distribution information, predetermined product information, and a predetermined target frozen state.
